(19) United States
(12) Patent Application Publication
(10) Pub. No.: US 2021/0402865 A1
(43) Pub. Date: Dec. 30, 2021

(54) HYBRID CLUTCH MANAGEMENT METHOD

(71) Applicant: VALEO EMBRAYAGES, Amiens Cedex 2 (FR)

(72) Inventor: Pascal MAUREL, Cergy Pontoise Cedex (FR)

(73) Assignee: VALEO EMBRAYAGES, Amiens Cedex 2 (FR)

(21) Appl. No.: 17/293,685

(22) PCT Filed: Nov. 13, 2019
(86) PCT No.: PCT/EP2019/081187

§ 371 Date: May 13, 2021

(30) Foreign Application Priority Data
Nov. 14, 2018 (FR) 1860482

(51) Int. Cl. B60K 6/387; B60W 10/02; B60W 10/06; B60W 10/08; B60W 20/40

(52) U.S. Cl. CPC B60K 6/387; B60W 10/02; B60W 2050/0012; B60W 10/08; B60W 20/40; B60W 10/06

(57) ABSTRACT

A method for starting a combustion engine of a hybrid motor vehicle drivetrain, in which there is a connection clutch interposed between the combustion engine and the electric motor for transmitting a torque between the combustion engine and the electric motor, and a main clutch interposed between the gearbox and the electric motor. From an initial state in which the electric motor generates a drive torque and the combustion engine is stopped, the main clutch is kept in a closed state so as to transmit the torque generated by the electric motor to the gearbox, and the connection clutch is controlled so as to transmit a drive torque between the electric motor and the combustion engine and perform a torque-limiting function between the combustion engine and the electric motor in order to limit the transmission of acyclisms between the combustion engine and the electric motor.

### TECHNICAL FIELD

The invention relates to the field of hybrid vehicles.

### TECHNOLOGICAL BACKGROUND

The objective of reducing emissions is leading to the increasing use of an electric motor and a combustion engine in combination in vehicles. A preferred architecture is the architecture where an electric motor is inserted between a combustion engine and a gearbox. In order to avoid losses in the combustion engine when only the electric motor generates a torque intended for the wheels of the vehicle, in particular in order to avoid the compensation of losses by pumping by the electric motor, a connection clutch interposed between the combustion engine and the electric motor is kept open to interrupt the mechanical link between the electric motor and the combustion engine when stopped.

In general, the vehicle starts off using the electric motor and then switches to operation using the combustion engine when the supervisor of the drivetrain decides it as a function of the battery state of charge of the electric motor or as a function of the power required at the wheel by the driver. The combustion engine is then started by means of the electric motor and the connection clutch.

In the prior art, the main clutch is kept slipping while the combustion engine starts to filter the torque jolts associated with the first combustions, which generates losses in the main clutch which must be compensated for by fuel consumption.

### SUMMARY

A better approach consists in keeping the main clutch engaged to avoid this unnecessary dissipation and to compensate for the losses of torque associated with the first combustions of the combustion engine with the electric motor and the control of the connection clutch and of the combustion engine. The invention proposes to describe the various steps and processes for controlling the electric motor, the connection clutch and the combustion engine in order to start the latter.

One idea on which the invention is based is to propose a method for controlling a drivetrain that is simple, efficient and reliable. In particular, one idea on which the invention is based is to avoid losses at the level of the main clutch. One idea on which the invention is based is to compensate for the torque losses associated with the first combustions by controlling the electric motor, the connection clutch and the combustion engine.

According to one embodiment, the invention provides a method for managing the starting of a combustion engine of a motor vehicle drivetrain, the drivetrain comprising:
a combustion engine,
an electric motor,
a gearbox,
a connection clutch arranged between the combustion engine and the electric motor to transmit a torque between the combustion engine and the electric motor,
a main clutch arranged between the gearbox and the electric motor to transmit torque between the electric motor and the gearbox,
a torsion damper arranged between the combustion engine and the connection clutch, the torsion damper having an operating range defined between a direct threshold torque and a reverse threshold torque, in which method, from an initial state
in which the electric motor generates a drive torque and the combustion engine is stopped, the main clutch is maintained in an engaged state so as to transmit the torque generated by the electric motor to the gearbox, and the connection clutch is controlled so as to transmit a drive torque from the electric motor to the combustion engine in order to start the combustion engine and perform a torque-limiting function between the combustion engine and the electric motor in order to limit the torque passing through the torsion damper in the operating range of said torsion damper.

Thanks to these features, it is possible to start the combustion engine without losses at the level of the main clutch. In particular, it is possible to start the combustion engine without slipping at the level of the main clutch by using the connection clutch as a torque limiter making it possible to limit the transmission of acyclisms in the drivetrain. Furthermore, the control of the connection clutch makes it possible to have control over the driving of the combustion engine by the electric motor without needing to compensate for the losses associated with the starting acyclisms of the combustion engine by the electric motor. In addition, the control of the connection clutch makes it possible to limit the torque passing through the torsion damper in order to prevent saturation of said torsion damper.

According to other advantageous embodiments, such a method may have one or more of the following features:

According to one embodiment, the connection clutch is in a biting point position when the speed of the combustion engine becomes greater than the speed of the electric motor. The biting point position of the connection clutch corresponds to a position of said connection clutch from which the clutch is capable of transmitting a nonzero torque.

According to one embodiment, the method further comprises:
a first step of engaging the connection clutch to a position in which a drive torque is transmitted from the electric motor to the combustion engine in order to drive said combustion engine in rotation and start it,
a step of increasing the speed of the engine after starting it;
a step of moving the connection clutch to an open position of said connection clutch before the speed of the combustion engine becomes greater than the speed of the electric motor; and
a second step of engaging the connection clutch, after the speed of the combustion engine has become greater than the speed of the electric motor, in which the connection clutch is engaged so as to transmit a torque making it possible to synchronize the speed of the combustion engine and the speed of the electric motor.

Thanks to these features, the combustion engine and the connection clutch are controlled so as to avoid shocks in the drivetrain when the speed of the combustion engine exceeds the speed of the electric motor. In particular, this opening of the connection clutch prevents the driver from feeling the reversal of the direction of rotation of the torsion damper when the speed of the combustion engine exceeds the speed of the electric motor. In addition, these features allow simple and reliable synchronization of the speed of the combustion engine and of the speed of the electric motor.

According to one embodiment, the first step of engaging the connection clutch comprises a phase of pre-positioning the connection clutch in which the connection clutch is moved to a biting point position and the speed of the electric motor is increased, and a phase of engaging the connection clutch so as to increase the torque transmissible by said connection clutch until a drive torque is transmitted from the electric motor to the combustion engine. This increase in the speed of the electric motor and the pre-positioning of the connection clutch makes it possible to anticipate the resistive torque of the combustion engine.

According to one embodiment, the method further comprises a step of calculating a pre-positioning torque setpoint as a function of the reverse threshold torque of the torsion damper, and in which the injection into the combustion engine is started and the combustion engine is controlled as a function of said pre-positioning torque setpoint before the speed of the combustion engine becomes greater than the speed of the electric motor. Thus, the pre-positioning torque setpoint is determined so that the torque passing through the torsion damper remains within the operating range of said torsion damper when starting the combustion engine. Thus, it is possible to limit the wear and degradation of the torsion damper and to increase its service life. These features thus make it possible to avoid over-torques liable to damage components of the drivetrain.

According to one embodiment, the injection into the combustion engine is started when the speed of the combustion engine reaches a threshold speed. According to one embodiment, the threshold speed is below a speed of synchronization between the speed of the combustion engine and the speed of the electric motor and the connection clutch is in a slipping engagement position when starting the injection into the combustion engine. According to one embodiment, the threshold speed is greater than a speed of synchronization between the speed of the combustion engine and the speed of the electric motor and the connection clutch is in an open position when the injection into the combustion engine is started.

According to one embodiment, the method further comprises a step of calculating a pre-positioning torque setpoint as a function of the direct threshold torque of the torsion damper, and in which the combustion engine is controlled as a function of said pre-positioning torque setpoint after the speed of the combustion engined becomes greater than the speed of the electric motor.

Thus, the pre-positioning torque setpoint is determined so that the torque passing through the torsion damper remains within the operating range of said torsion damper during synchronization of the speeds of the combustion engine and of the electric motor. Thus, it is possible to limit the wear and degradation of the torsion damper and to increase its service life.

According to one embodiment, the step of calculating a pre-positioning torque setpoint comprises the steps of:
calculating a deflection of the torsion damper,
calculating a maximum acceleration of the combustion engine to reach a threshold torque of the torsion damper as a function of the deflection of the torsion damper, of said threshold torque, and of a variable representative of the acceleration of the combustion engine, said threshold torque being a function of the deflection of the torsion damper,
calculating the pre-positioning torque setpoint as a function of the maximum acceleration of the combustion engine.

According to one embodiment, the step of calculating a pre-positioning torque setpoint further comprises a step of calculating a modulated control setpoint of the combustion engine as a function of the calculated maximum acceleration, the pre-positioning torque setpoint being calculated as a function of said modulated control setpoint. The pre-positioning torque setpoint is, for example, modulated as a function of a target acceleration by means of a corrector of P+I type with closed loop on the acceleration.

The variable representative of the acceleration of the combustion engine may take various forms. According to one embodiment, the variable representative of the acceleration of the combustion engine is the measured acceleration of the combustion engine.

According to one embodiment, the threshold torque is the direct threshold torque when the deflection of the torsion damper corresponds to a deflection in the direct direction, that is to say a deflection of the torsion damper associated with a torque passing from the combustion engine to the electric motor. According to one embodiment, the threshold torque is the reverse threshold torque when the deflection of the torsion damper corresponds to a deflection in the reverse direction, that is to say a deflection associated with a torque passing from the electric motor to the combustion engine. In other words, the threshold torque is the reverse threshold torque when the speed of the combustion engine is lower than the speed of the electric motor, and the threshold torque is the direct threshold torque when the speed of the combustion engine is greater than the speed of the electric motor.

According to one embodiment, the method further comprises a step of calculating a connection clutch setpoint as a function of the pre-positioning torque setpoint and of the threshold torque of the torsion damper, the position of the connection clutch being controlled as a function of said connection clutch setpoint before the speed of the combustion engine becomes greater than the speed of the electric motor.

According to one embodiment, the method further comprises a step of calculating a connection clutch setpoint as a function of the pre-positioning torque setpoint and of the reverse threshold torque of the torsion damper, the position of the connection clutch being controlled as a function of said connection clutch setpoint after the speed of the combustion engine becomes greater than the speed of the electric motor.

Thanks to these features, it is possible to control the torque passing through the connection clutch so as to avoid saturation of the torsion damper. Thus, it is possible to limit the wear and degradation of the torsion damper and to increase its service life. These features thus make it possible to avoid over-torques liable to damage components of the drivetrain.

According to one embodiment, the step of calculating the connection clutch setpoint comprises the steps of:
measuring an acceleration of the combustion engine,
calculating a torque setpoint correction as a function of the acceleration of the combustion engine measured and of the maximum acceleration of the combustion engine,
calculating a torque setpoint corrected as a function of the torque setpoint correction and of the pre-positioning torque setpoint,
calculating the connection clutch setpoint as a function of the pre-positioning torque setpoint and of the corrected torque setpoint.

According to one embodiment, the step of calculating the connection clutch setpoint further comprises a step of comparing the acceleration of the combustion engine measured and the modulated acceleration setpoint.

According to one embodiment, the calculation of the torque setpoint correction is performed as a function of the difference between the acceleration of the combustion engine measured and the modulated acceleration setpoint.

According to one embodiment, the step of calculating the connection clutch setpoint comprises the steps of:
calculating a speed setpoint of the combustion engine as a function of the calculated maximum acceleration,
measuring a speed of the combustion engine,
comparing the measured speed and the speed setpoint of the combustion engine,
calculating a torque setpoint correction as a function of the difference between the measured speed and the speed setpoint of the combustion engine,
calculating a torque setpoint corrected as a function of the torque setpoint correction and of the pre-positioning torque setpoint,
calculating the connection clutch setpoint as a function of the pre-positioning torque setpoint and of the corrected torque setpoint.

According to one embodiment, the calculation of the torque setpoint correction is modulated as a function of the connection clutch setpoint. Thanks to these features, the torque setpoint correction is perfectly controlled.

### BRIEF DESCRIPTION OF THE FIGURES

The invention will be better understood, and other aims, details, features and advantages thereof will become clearer, from the following description of a plurality of particular embodiments of the invention, provided solely by way of nonlimiting illustration, with reference to the attached drawings.

FIG. 1 is a schematic representation of a motor vehicle hybrid drivetrain;

FIG. 2 is a graph illustrating the torque transmissible by the connection clutch, the speed of the electric motor and the speed of the combustion engine in the drivetrain of FIG. 1 during a starting sequence of the combustion engine;

FIG. 3 is a diagram illustrating the method for controlling the electric motor and the combustion engine of FIG. 1 during a phase of starting driving of the combustion engine;

FIG. 4 is a diagram illustrating a variant of the method for controlling the combustion engine and the electric motor of FIG. 3;

FIG. 5 is a diagram illustrating an exemplary embodiment of the modulation of the torque setpoint of the combustion engine.

### DESCRIPTION OF THE EMBODIMENTS

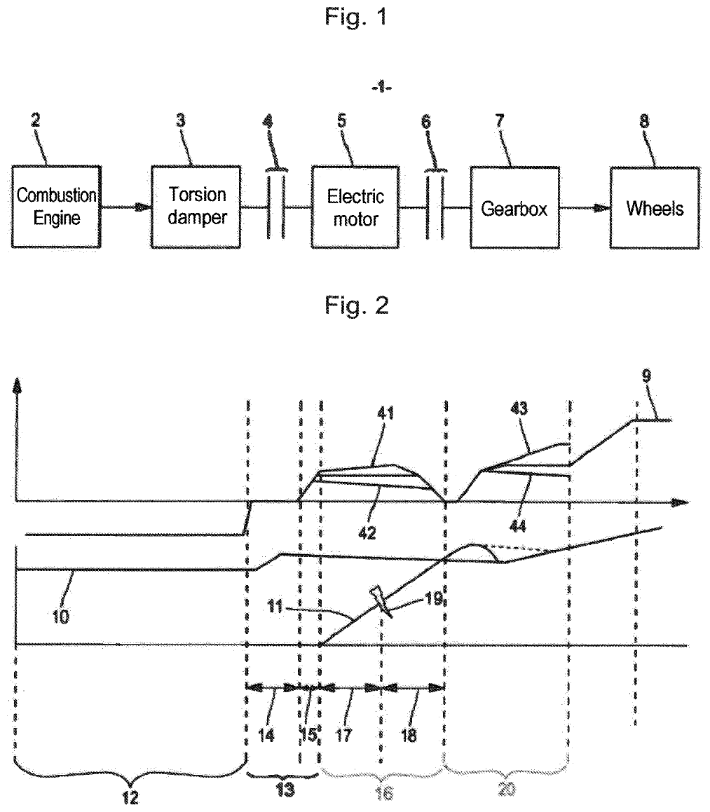

FIG. 1 schematically represents a drivetrain 1 of a hybrid vehicle.

This drivetrain 1 comprises successively, in the example considered, along a torque transmission path, a combustion engine 2, a torsion damper 3, such as a dual mass flywheel, a first clutch hereinafter referred to as the connection clutch 4, an electric motor 5, a second clutch hereinafter referred to as the main clutch 6, and a gearbox 7. This drivetrain 1, and more particularly the gearbox 7, is connected to the wheels 8 of the vehicle. In this drivetrain 1, the electric motor 5 is arranged, along the torque transmission path, between the combustion engine 2 and the gearbox 7. The electric motor 5 may be in a position aligned with the drivetrain or misaligned with the drivetrain. In the case of a misaligned electric motor 5, a shaft of the electric motor 5 is connected to the drivetrain by a belt, a chain, a cascade of gears or any other suitable connection means. Furthermore, the main clutch 6 may be a double clutch, the lockup of a torque converter or the like.

In an electric transmission mode, the electric motor 5 alone generates the torque making it possible to drive the wheels 8, and the combustion engine 2 is stopped. In order to avoid losses in the combustion engine 2, the connection clutch 4 is kept in an open position to interrupt the mechanical connection between the electric motor 5 and the combustion engine 2.

In general, the vehicle starts off by means of the electric motor 5, and the combustion engine 2 is put into operation when the supervisor of the drivetrain 1 so decides, for example as a function of the state of charge of the battery associated with the electric motor 5 or as a function of the power requested by the driver. The combustion engine 2 is then started by means of the electric motor 5 and the connection clutch 4.

FIG. 2 contains a first graph illustrating a maximum torque 9 transmissible by the connection clutch 4 during the starting of the combustion engine 2 and a second graph illustrating the speed 10 of the electric motor 5 and the speed 11 of the combustion engine 2 during this starting of the combustion engine 2. The curve 9, illustrating the maximum torque transmissible by the connection clutch, corresponds to a position of said connection clutch 4. Typically, from a biting point position corresponding to an engagement state of the connection clutch 4 from which torque may be transmitted by the connection clutch 4, the further the connection clutch moves toward a maximum engagement state, the higher the maximum transmissible torque 9.

In an initial state 12, as indicated above, the combustion engine 2 is stopped and only the electric motor 5 produces a torque transmitted to the gearbox 7 via the main clutch 6, which is then in an engaged position. The connection clutch 4 is itself in an open position and does not allow torque to be transmitted between the combustion engine 2 and the electric motor 5. Thus, no torque 9 passes between the electric motor 5 and the combustion engine 2.

For the sake of readability, in order to differentiate the various opening positions of the connection clutch 4, the curve 9 is negative between a maximum opening position of said connection clutch 4 and the biting point position. Thus, in the maximum opening state of the connection clutch 4, the curve 9 is negative although the torque transmissible by said connection clutch is zero. Further, when the connection clutch 4 moves from the maximum opening position of said connection clutch 4 in the direction of the biting point position, the curve 9 remains negative but increases in the direction of the x-axis although, during this movement, the maximum torque transmissible by the connection clutch 4 remains zero.

In this initial state 12, the electric motor 5 has a positive speed 10. Conversely, the combustion engine 2 being stopped in this initial state 12 has a zero speed 11.

During a first step 13 of starting the combustion engine 2, the connection clutch 4 and the electric motor 5 are pre-positioned to allow the starting of the combustion engine 2. For this, during a first phase 14, the connection clutch 4 is positioned at the biting point of said connection clutch 4. This positioning of the connection clutch 4 at the biting point makes it possible to prepare the starting phase of the combustion engine 2.

During this first phase 14, the electric motor 5 and the main clutch 6 are controlled so that the electric motor 5 transmits a torque to the wheels that is capable of maintaining the speed or the acceleration of the vehicle corresponding to the driver's request.

Furthermore, at the same time, the speed 10 of the electric motor 5 is increased in order to anticipate the engagement of the connection clutch 4. Then, during a second phase 15 of this first pre-positioning step 13, that is to say when the speed 10 of the electric motor 5 is sufficient, the connection clutch 4 is moved in the direction of a fully engaged position in order to allow an increase in the maximum torque 9 transmissible by the connection clutch 4. This pre-positioning is carried out in open loop so as to obtain a torque transmitted by the connection clutch 4 which is calculated as a function of a maximum torque setpoint transmissible by the connection clutch 4 in order to limit the deflection of the torsion damper 3. At the same time, the electric motor 5 and the main clutch 6 are always controlled so that the electric motor 5 transmits torque to the wheels that is capable of maintaining the speed or the acceleration of the vehicle corresponding to the driver's request.

Owing to the engagement of the connection clutch 4, the electric motor 5 sees its speed 10 decrease owing to the resistive torque generated by the combustion engine 2, which is still stopped.

The engagement of the connection clutch 4 allows an increase in the maximum torque 9 transmissible by the connection clutch 4 up to a value sufficient to allow the combustion engine 2 to be driven by the electric motor 5. In other words, during a second step 16, with the connection clutch 4 being engaged, the torque generated by the electric motor 5 is transmitted to the combustion engine 2 via the connection clutch 4. Thus, the torque 9 passing through the connection clutch 4 drives the combustion engine 2 in rotation. This driving results in an increase in the speed 11 of the combustion engine 2, as illustrated in FIG. 2.

The rotational driving of the combustion engine 2 is broken down into two phases, a first phase 17 during which the combustion engine 2 is driven in rotation by the electric motor 5 alone, and a second phase 18 during which the combustion engine 2 itself generates a torque.

The first phase 17 corresponds to the combustion engine 2 being driven by the electric motor 5 in order to start the injection into the combustion engine 2. During this first phase 17, the electric motor 5 and the main clutch 6 are controlled so that the electric motor 5 transmits a torque to the wheels that is capable of maintaining the speed or the acceleration of the vehicle corresponding to the driver's request.

As soon as the measurement of the acceleration of the combustion engine 2 is possible, the torque setpoint, in open-loop pre-positioning of the connection clutch 4, has added thereto a torque setpoint resulting from the regulation, by the connection clutch 4, of the acceleration of the speed 11 of the combustion engine 2 deduced from the maximum torque transmissible by the connection clutch 4 limited as a function of the maximum deflection of the torsion damper 3 and of the value of the inertia upstream of the connection clutch 4, defined by the engine inertia of the combustion engine 2, the inertia of the torsion damper 3 and the plate of the connection clutch 4.

The second phase 18 corresponds to a phase during which the engine speed of the combustion engine 2 is sufficient to start the injection into the combustion engine 2 and drive said combustion engine 2 in rotation. The junction between the two phases is illustrated schematically in FIG. 2 by the mark 19, which therefore corresponds to the time of starting the combustion engine 2 during which the speed 11 of said combustion engine is sufficient to start the injection necessary to operate said combustion engine. 2.

When the injection into the combustion engine 2 is sufficient to drive the combustion engine 2 in rotation, that is to say during the second phase 18, the connection clutch 4 is moved toward the biting point position. In other words, at the end of this second phase 18, when the speed 11 of the combustion engine 2 approaches the intersection with the speed 10 of the electric motor 5, the connection clutch 4 is disengaged in open loop. Thus, as illustrated in FIG. 2, the maximum torque 9 transmissible by the connection clutch 4 gradually decreases between the instant 19 corresponding to the starting of the combustion engine 2 and the instant when the speed 11 of the combustion engine 2 reaches the speed 10 of the electric motor 5. The movement of the connection clutch 4 toward its open position makes it possible to limit the transmission of torque between the combustion engine 2 and the electric motor 5 during the second phase 18 of starting the combustion engine 2. This disconnection between the electric motor 5 and the combustion engine 2 makes it possible not to transmit to the electric motor 5, and therefore to the gearbox 7, the acyclisms generated by the combustion engine 2 during this second phase 18 of starting the combustion engine 2. Specifically, during this second phase 18 of starting the combustion engine 2, the acyclisms generated by the combustion engine 2 are particularly large and are therefore detrimental to the drivetrain 1 and to driver feel.

Furthermore, as illustrated in FIG. 2, the connection clutch 4 is controlled to reach an open position close to the biting point when the speed 11 of the combustion engine 2 reaches the speed 11 of the electric motor 5. Specifically, this opening of the connection clutch 4 makes it possible to avoid shocks when the speed 11 of the combustion engine 2 reaches and exceeds the speed 10 of the electric motor 5.

When the speed 11 of the combustion engine 2 reaches the speed 10 of the electric motor 5, the combustion engine 2 and the electric motor 5 may be combined to jointly generate the drive torque allowing the movement of the vehicle. Thus, during a third step 20, the connection clutch 4 is moved in the direction of the fully engaged position in order to allow the transmission of torque between the combustion engine 2 and the electric motor 5. This engagement of the connection clutch 4 makes it possible to synchronize the speed 10 of the electric motor 5 and the speed 11 of the combustion engine 2. This engagement of the connection clutch 4 results in an increase in the maximum torque 9 transmissible by said connection clutch 4, as illustrated in FIG. 2.

During the synchronization phase corresponding to this third step 20, the engine speed 11 of the combustion engine 2 is regulated and the connection clutch 4 is moved toward its engaged position with a torque pre-positioning corresponding to the drive torque corrected with a slip regulation of the speed of the connection clutch 4 to avoid torque oscillations and ensure that the acceleration of the combustion engine 2 and of the electric motor 5 are very close to the synchronization of the speeds.

Once synchronized, the connection clutch is brought in open loop to its maximum torque capacity. Specifically, as soon as the combustion engine 2 and the electric motor 5 are synchronized, then said motors 2, 5 may be controlled jointly to generate the torque desired by the driver of the vehicle, and the connection clutch 4 may be moved toward its engaged position, as illustrated by the increase in the maximum torque 9 transmissible by the connection clutch 4 and the corresponding and synchronized increases in speed 11, 12.

As explained above, the starting of the injection into the combustion engine 2 may be triggered as soon as an engine speed 11 of the combustion engine 2 is sufficient, for example at an engine speed 11 of the order of 600 to 700 revolutions per minute. However, in one embodiment that has not been illustrated, the injection into the combustion engine 2 may be triggered when the speed 11 of the combustion engine 2 reaches a speed greater than the motor speed 10 of the electric motor 5 and when the connection clutch 4 is in an open position or close to the biting point. Therefore, when the combustion engine 2 is started, that is to say the injection into said combustion engine 2 is operational, said combustion engine 2 is controlled in speed so as to bring its engine speed 11 close to the motor speed 10 of the electric motor 5, but in excess, the synchronization being carried out from a speed 11 of the combustion engine 2 that is greater than the speed 10 of the electric motor 5.

When starting the combustion engine 2, the acyclisms generated by the combustion engine 2 are at least partially damped by the torsion damper 3 interposed between the combustion engine 2 and the connection clutch 4. However, with a torque passing through the connection clutch 4 during the two phases 17, 18 of starting the combustion engine 2, the deformations of the torsion damper 3 are also associated with the torque generated by the electric motor 5 and passing through the connection clutch 4. Thus, the torsion damper 3 may undergo significant deformations which could result in saturation thereof, which would no longer make it possible to ensure filtering of acyclisms and would not allow effective protection of the various elements of the drivetrain 1.

To avoid this, the starting method provides for modulating the torque generated by the combustion engine 2 and the maximum torque 9 transmissible by the connection clutch 4.

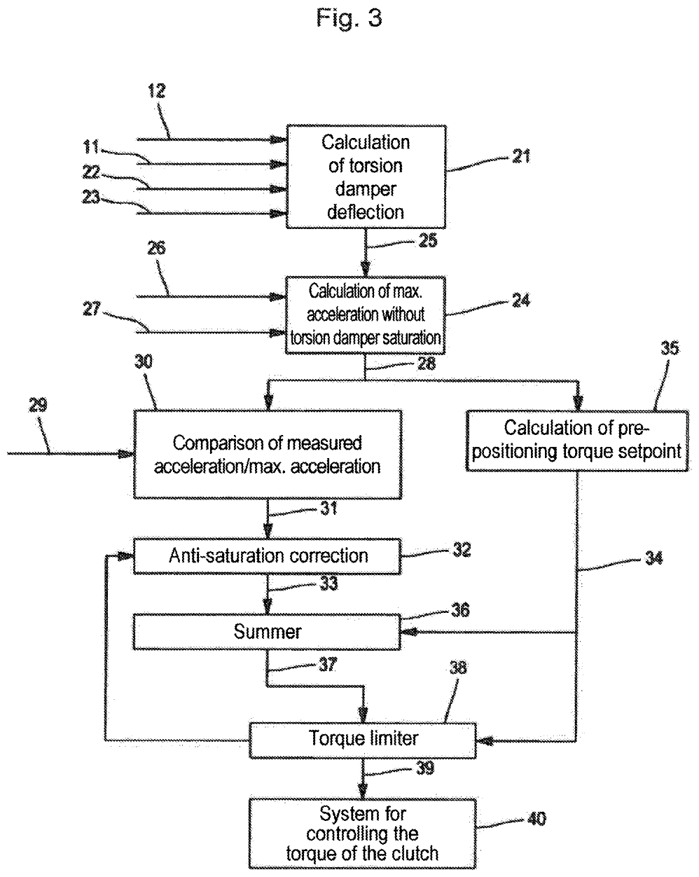

FIG. 3 illustrates a diagram representing the various steps implemented by this method of modulating the phase 17. Such a method is, for example, implemented at the level of a control member for the various elements of the drivetrain 1 and uses ad hoc sensors intended to measure the parameters useful for said method, such as accelerometers, speed sensors, force sensors or others. In a preferred embodiment, the engine speed sensor or the engine speed information transmitted via the network by the combustion engine computer is used more particularly.

During a first step 21, an estimate of the deformation of the torsion damper 3 is calculated. This deformation of the torsion damper 3 is calculated as a function of the speed 11 of the combustion engine 2, of the speed 10 of the electric motor 5, of the torque 22 generated by the combustion engine 2 and of the torque 23 generated by the electric motor 5.

A second step 24 consists in calculating a maximum acceleration beyond which the torsion damper 3 would be saturated, that is to say in a position of maximum deflection beyond which the damping members of said torsion damper 3 are no longer able to damp the acyclisms of the combustion engine 2. This maximum acceleration is determined as a function of the current deflection 25 of the torsion damper 3 calculated during step 21, of the maximum deflection 26 of the torsion damper 3, and of the acceleration setpoint 27 of the combustion engine 2.

The maximum deflection 26 of a torsion damper 3 is specific to each torsion damper 3; in other words, this maximum deflection 26 is a predefined item of data, for example given by the manufacturer of said torsion damper 3. It generally corresponds to the angular deflection from which the turns of the springs abut against one another or the springs are short-circuited in order to protect them. This maximum deflection is defined for a rotation of the elements of the torsion damper in the two possible directions of rotation. The torsion damper 3 therefore has a direct threshold torque beyond which the torsion damper is saturated when the torque generated by the combustion engine 2 is greater than the torque generated by the electric motor 5 and when the difference between the torque of the combustion engine 2 and the torque of the electric motor 5 is greater than said direct threshold torque. Likewise, the torsion damper has a reverse threshold torque beyond which the torsion damper is saturated when the torque generated by the electric motor 5 is greater than the torque generated by the combustion engine 2 and when the difference between the torque of the electric motor 5 and the torque of the combustion engine 2 is greater than said reverse threshold torque.

Furthermore, the term “torsion damper” is understood to mean any type of damper which may become saturated, such as, for example, a dual mass flywheel or else a pendulum whose oscillating masses could be brought into abutment.

The acceleration setpoint 27 of the combustion engine 2 is obtained by any means.

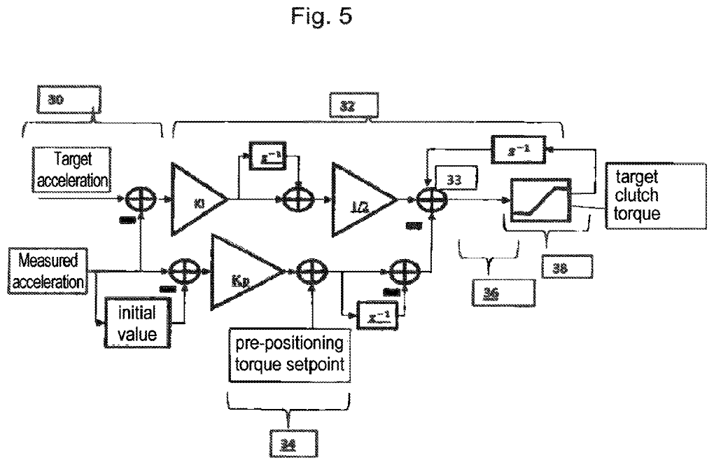

A limited acceleration setpoint 28 of the combustion engine 2 is then calculated from this maximum acceleration obtained during the second step 24, for example by calculating a torque as a function of the maximum deflection and of the stiffness of the torsion damper, then by calculating the acceleration from the calculated torque and the engine inertia or else, in the case of a pendulum, by using a speed/deflection table giving the torque. A comparison is then made between this limited acceleration setpoint 28 and the measured acceleration 29 of the combustion engine 2 (step 30). This comparison 30 makes it possible to calculate an engine acceleration difference 31 between the limited acceleration setpoint 28 and the measured acceleration 29. This engine acceleration difference 31 is transmitted to an anti-saturation corrector 32 which generates a torque setpoint correction 33 as a function of said engine acceleration difference 31 in order to avoid saturation of the torsion damper 3. FIG. 5 illustrates an example of the implementation of the calculation of such a correction.

As illustrated in FIG. 5, in parallel with this calculation of the torque setpoint correction 33, a pre-positioning torque setpoint 34 of the clutch is calculated (step 35) from the limited acceleration setpoint 28. This torque setpoint 34 is transmitted jointly with the torque setpoint correction 33 to a summer 36 and is used by said summer 36 to generate a corrected clutch torque setpoint 37. The torque setpoint 34 and the corrected clutch torque setpoint 37 are transmitted to a torque limiter 38 which generates a control signal 39 of the torque control system of the connection clutch 4 as a function of the difference between the torque setpoint 34 and the corrected clutch torque setpoint 37 (step 40). Furthermore, this torque limiter transmits an item of data representative of this difference to the anti-saturation corrector, which adapts the torque correction setpoint 33 as a function of said difference between the torque setpoint 34 and the corrected clutch torque setpoint 37.

In FIG. 2, the control of the connection clutch 4 and of the combustion engine 2 according to the method described above with reference to FIG. 3 results in curves 41, 42 of maximum torque transmissible by the connection clutch 4 that are modulated during the second phase 18 of the method described above with reference to FIG. 2. Typically, the combustion engine 2 and the connection clutch 4 are controlled so that the torque 9 transmissible by the connection clutch 4 is increased as illustrated by the curve portion 41 when the torsion damper 3 is not saturated and is reduced as illustrated by the curve portion 42 when the torque passing through the connection clutch 4 is liable to saturate the torsion damper 3.

This modulation of the maximum torque transmissible by the connection clutch 4 may also be implemented in the starting process during the phase of synchronization between the combustion engine 2 and the electric motor 5. Thus, the connection clutch 4 may be controlled during the synchronization step 20 to allow greater torque transmission as illustrated by the curve portion 43 in FIG. 2 or, on the contrary, a limited torque transmission as illustrated by the curve portion 44 as a function of the saturation state of the torsion damper 3.

The control of the connection clutch 4 in order to avoid saturation of the torsion damper 3 is described above using acceleration values of the combustion engine 2. However, this control of the connection clutch 4 could also be carried out as a function of the speed values 11 of the combustion engine. 2.

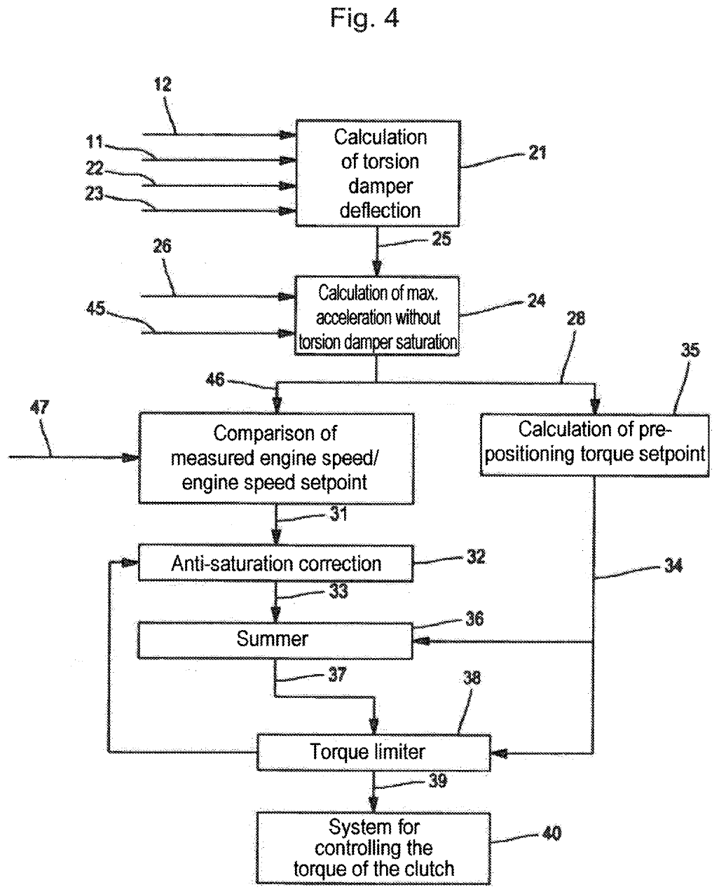

Thus, in FIG. 4, step 24 of calculating the maximum acceleration without saturation of the torsion damper 3 is calculated from the current deflection 25 of the torsion damper 3 calculated during step 21, the maximum deflection 26 of the torsion damper 3 and the measured acceleration 45 of the combustion engine 2. This calculation of the maximum acceleration 24 makes it possible to generate, in addition to the limited torque setpoint 28 intended for calculating the torque setpoint of the combustion engine (step 35), a speed setpoint 46 which is transmitted to the comparator. In other words, the comparison step 30 in order to determine the engine acceleration 31 is carried out as a function of the speed setpoint 46 and of the measured speed 47 and not as a function of the acceleration setpoint 28 and of the measured acceleration. 29. Once the engine acceleration 31 has been determined, the rest of the control method is analogous to that described above with reference to FIG. 3.

Although the invention has been described in connection with a plurality of particular embodiments, it is quite obvious that it is in no way limited thereto and that it encompasses all the technical equivalents of the means described and combinations thereof where these fall within the scope of the invention.

The use of the verb “have”, “comprise” or “include” and conjugated forms thereof does not exclude the presence of elements or steps other than those stated in a claim. The use of the indefinite article “a” or “an” for an element or a step does not exclude, unless otherwise specified, the presence of a plurality of such elements or steps.

In the claims, any reference sign between parentheses should not be interpreted as limiting the claim.

1. A method for managing the starting of a combustion engine of a motor vehicle drivetrain, the drivetrain comprising:
a combustion engine,
an electric motor,
a gearbox,
a connection clutch arranged between the combustion engine and the electric motor to transmit a torque between the combustion engine and the electric motor,
a main clutch arranged between the gearbox and the electric motor to transmit a torque between the electric motor and the gearbox,
a torsion damper arranged between the combustion engine and the connection clutch, the torsion damper having a defined operating range between a direct threshold torque and a reverse threshold torque, in which method, from an initial state in which the electric motor generates a drive torque and the combustion engine is stopped, the main clutch is kept in an engaged state so as to transmit the torque generated by the electric motor to the gearbox, and the connection clutch is controlled so as to transmit a drive torque from the electric motor to the combustion engine in order to start the combustion engine and perform a torque-limiting function between the combustion engine and the electric motor in order to limit the torque passing through the torsion damper in the operating range of said torsion damper.

2. The method as claimed in claim 1, comprising
a first step of engaging the connection clutch to a position in which a drive torque is transmitted from the electric motor to the combustion engine in order to drive said combustion engine in rotation and start it,
a step of increasing the speed of the combustion engine after it has started;
a step of moving the connection clutch to an open position of said connection clutch before the speed of the combustion engine becomes greater than the speed of the electric motor; and
a second step of engaging the connection clutch, after the speed of the combustion engine has become greater than the speed of the electric motor, in which the connection clutch is engaged so as to transmit a torque making it possible to synchronize the speed of the combustion engine and the speed of the electric motor.

3. The method as claimed in claim 1, in which the first step of engaging the connection clutch comprises a phase of pre-positioning the connection clutch in which the connection clutch is moved to a biting point position and the speed of the electric motor is increased, and a phase of engaging the connection clutch so as to increase the torque transmissible by said connection clutch until a drive torque is transmitted from the electric motor to the combustion engine.

4. The method as claimed in claim 1, comprising a step of calculating a pre-positioning torque setpoint as a function of the reverse threshold torque of the torsion damper, and in which the injection into the combustion engine is started and the combustion engine is controlled as a function of said pre-positioning torque setpoint before the speed of the combustion engine becomes greater than the speed of the electric motor.

5. The method as claimed in claim 4, in which the injection into the combustion engine is started when the speed of the combustion engine reaches a threshold speed.

6. The method as claimed in claim 4, in which the step of calculating a pre-positioning torque setpoint comprises the steps of
calculating a deflection of the torsion damper,
calculating a maximum acceleration of the combustion engine to reach a threshold torque of the torsion damper as a function of the deflection of the torsion damper, of said threshold torque, and of a variable representative of the acceleration of the combustion engine, said threshold torque being a function of the deflection of the torsion damper,
calculating the pre-positioning torque setpoint as a function of the maximum acceleration of the combustion engine.

7. The method as claimed in claim 1, comprising a step of calculating a connection clutch setpoint as a function of the pre-positioning torque setpoint and of the threshold torque of the torsion damper, the position of the connection clutch being controlled as a function of said connection clutch setpoint before the speed of the combustion engine becomes greater than the speed of the electric motor.

8. The method as claimed in claim 7, in which the step of calculating the connection clutch setpoint comprises the steps of:
measuring an acceleration of the combustion engine,
calculating a torque setpoint correction as a function of the acceleration of the combustion engine measured and of the maximum acceleration of the combustion engine,
calculating a corrected torque setpoint corrected as a function of the torque setpoint correction and of the pre-positioning torque setpoint,
calculating the connection clutch setpoint as a function of the pre-positioning torque setpoint and of the corrected torque setpoint.

9. The method as claimed in claim 7, in which the step of calculating the connection clutch setpoint comprises the steps of:
calculating a speed setpoint of the combustion engine as a function of the calculated maximum acceleration,
measuring a speed of the combustion engine,
comparing the measured speed and the speed setpoint of the combustion engine,
calculating a torque setpoint correction as a function of the difference between the measured speed and the speed setpoint of the combustion engine,
calculating a corrected torque setpoint corrected as a function of the torque setpoint correction and of the pre-positioning torque setpoint,
calculating the connection clutch setpoint as a function of the pre-positioning torque setpoint and of the corrected torque setpoint.

10. The method as claimed in claim 8, in which the calculation of the torque setpoint correction is modulated as a function of the connection clutch setpoint.
